(19) United States
(12) Patent Application Publication
(10) Pub. No.: US 2023/0075185 A1
(43) Pub. Date: Mar. 9, 2023

(54) METHOD AND SYSTEM FOR POSITIONING A MOVEABLE ROBOTIC SYSTEM

(71) Applicant: Ford Global Technologies, LLC, Dearborn, MI (US)

(72) Inventors: Hadi Atwi, Dearborn, MI (US); Richard Moore, Fenton, MI (US)

(73) Assignee: Ford Global Technologies, LLC, Dearborn, MI (US)

(21) Appl. No.: 17/470,812

(22) Filed: Sep. 9, 2021

(51) Int. Cl. B25J 9/16; G05B 19/418

(52) U.S. Cl. CPC B25J 9/1694; G05B 19/41895; G05B 2219/39001; G05B 2219/39172

(57) ABSTRACT

A method includes moving a locating feature associated with a robotic arm of the robotic system along a selected defined path to a detected position, where the detected position is a position of the locating feature when a force feedback condition is satisfied. The method includes calculating a positional offset of the robotic arm based on a nominal position and the detected position of the robotic arm. The method includes performing, by the robotic system, one or more operations at the manufacturing station using the positional offset.

### FIELD

The present disclosure relates to industrial robotic systems, and more particularly to a method and system for calibrating a moveable robotic arm at a manufacturing station.

### BACKGROUND

The statements in this section merely provide background information related to the present disclosure and may not constitute prior art.

In manufacturing, industrial robotic systems are commonly employed to perform repetitive motions and actions. For example, in the automotive industry, robotic systems having multi-axial robotic arms can be used to transfer workpieces in and out of manufacturing stations. Such robotic systems have typically been fixed to the manufacturing facility, but recent manufacturing developments provide for more dynamic manufacturing facilities in which robotic systems can autonomously move to different manufacturing stations. However, moving the robotic systems to different stations can lead to complex tolerance stack ups that can lead to other issues related to the accuracy at which the robotic systems are able to perform the repetitive motions and actions. These and other issues related to positional control and operation of robotic systems are addressed by the present disclosure.

### SUMMARY

This section provides a general summary of the disclosure and is not a comprehensive disclosure of its full scope or all of its features.

In one form, the present disclosure provides a method of operating a robotic system at a manufacturing station in a facility. The method includes moving a locating feature associated with a robotic arm of the robotic system along a selected defined path to a detected position, where the detected position is a position of the locating feature when a force feedback condition is satisfied. The method includes calculating a positional offset of the robotic arm based on a nominal position and the detected position of the robotic arm. The method further includes performing, by the robotic system, one or more operations at the manufacturing station using the positional offset.

In some forms, the method further includes having the robotic arm move the locating feature along a first defined path toward the nominal position, as the selected defined path, measuring force feedback data from one or more sensors provided at the robotic arm to determine whether the force feedback condition is satisfied as the locating feature moves along the selected defined path, and employing a current position of the locating feature as the detected position in response to the force feedback condition being satisfied.

In some forms, the method includes having the robotic arm move the locating feature along a second defined path from the nominal position, as the selected defined path, in response to the force feedback condition not being satisfied when the locating feature is moved to the nominal position.

In some forms, the detected position is provided prior to the locating feature reaching the nominal position.

In some forms, the method includes determining whether force feedback data from one or more sensors provided at the robotic arm is greater than or equal to a force threshold. The method includes determining the force feedback condition is satisfied in response to the force feedback data being greater than or equal to the force threshold.

In some forms, the one or more sensors includes one or more torque sensors.

In some forms, the nominal position is a trained reference position learned by the robotic system during a setup operation.

In some forms, the nominal position is associated with a structural feature of a machine provided at the manufacturing station, a positional fixture provided at the manufacturing station, or a combination thereof.

In some forms, the one or more operations include having the robotic system position a workpiece at a machine, remove the workpiece from the machine, or a combination hereof, where the machine is provided at the manufacturing station.

In one form, the present disclosure provides a robotic system. The robotic system includes a locating feature, a robotic arm associated with the locating feature and includes one or more sensors disposed thereon, and a controller. The controller is configured to move the locating feature along a selected defined path to a detected position, where the detected position is a position of the locating feature in response to a force feedback condition being satisfied at a manufacturing station. The controller is also configured to calculate a positional offset based on a nominal position and the detected position, where the nominal position is associated with the manufacturing station. The controller is further configured to have the robotic arm perform one or more operations at the manufacturing station using the positional offset.

In some forms, the controller is further configured to have the robotic arm move the locating feature along a first defined path toward the nominal position, as the selected defined path, measure force feedback data from one or more sensors provided on the robotic arm to determine whether the force feedback condition is satisfied as the locating feature moves along the selected defined path, and employ a current position of the robotic arm as the detected position in response to the force feedback condition being satisfied.

In some forms, the controller is further configured to have the robotic arm move the locating feature along a second defined path from the nominal position, as the selected defined path, in response to the force feedback condition not being satisfied when the locating feature is initially moved to the nominal position.

In some forms, the detected position is provided prior to the locating feature reaching the nominal position.

In some forms, the controller is further configured to determine whether force feedback data from the one or more sensors at the robotic arm is greater than or equal to a force threshold and determine the force feedback condition is satisfied in response to the force feedback data being greater than or equal to the force threshold.

In some forms, the nominal position is a trained reference position learned by the robotic system during a setup operation.

In some forms, the one or more sensors include one or more torque sensors.

In some forms, the nominal position is associated with a structural feature of a machine of the manufacturing station, a positional fixture associated with the manufacturing station, or a combination thereof.

In some forms, the robotic system further includes an automatic guided vehicle coupled to the robotic arm and configured to transport the robotic arm from a first location to the manufacturing station.

In some forms, the robotic system further includes: a gripper attached to the robotic arm and configured to handle a workpiece. As an operation from among the one or more operations, the controller is configured to have the robotic arm and the gripper position the workpiece at a machine, remove the workpiece from the machine, or a combination hereof, where the machine is provided at the manufacturing station.

In one form, the present disclosure provides a method for operating a robotic system at a manufacturing station in a facility. The method includes moving a locating feature associated with a robotic arm of the robotic system along a selected defined path, where a nominal position is provided along the selected defined path and the nominal position is a trained reference position associated with the manufacturing station. The method includes measuring force feedback data from one or more sensors provided at the robotic arm to determine whether the force feedback condition is satisfied as the locating feature moves along the selected defined path and calculating a positional offset of the robotic arm based on the nominal position and a detected position, where the detected position is a position of the locating feature when the force feedback condition is satisfied. The method includes performing, by the robotic system, one or more operations at the manufacturing station using the positional offset.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a manufacturing facility having multiple moveable robotic systems and multiple manufacturing stations in accordance with the teachings of the present disclosure;

FIG. 2 is a perspective view of an example end-effector tool in accordance with the teachings of the present disclosure;

FIG. 3 is a block diagram of a controller of a robotic system in accordance with the teachings of the present disclosure;

FIG. 4 is an illustrative diagram of a locating feature of the robotic system in association with a positional identifier in accordance with the teachings of the present disclosure;

FIG. 5 is an illustrative diagram of the locating feature of the robotic system locating in association with determining a detected position in accordance with the teachings of the present disclosure; and

FIG. 6 is a flowchart for a localization control routine in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In some applications, a robotic system having a multi-axial robotic arm may operate in tight tolerance (e.g., +/−7 mm or +/−5 mm) to perform manufacturing operations such as positioning workpieces in and transferring workpiece from a machine, such as an automated additive manufacturing production (AAMP) machine. The robotic system of the present disclosure is configured to perform a localization control routine at a selected manufacturing station to improve positional accuracy of the robotic system and more specifically, an end-effector tool of the robotic system that is configured to perform one or more operations at the station. During the localization control routine, the robotic system moves a locating feature associated with a robotic arm along a selected defined path to determine a detected position at which a force feedback condition is satisfied. A nominal position associated with the station is provided along the selected defined path. Once the detected position is obtained, the robotic system calculates a positional offset of the robotic arm based on the nominal position and the detected position, and the positional offset is used to control the robotic arm as it performs one or more operations at the station.

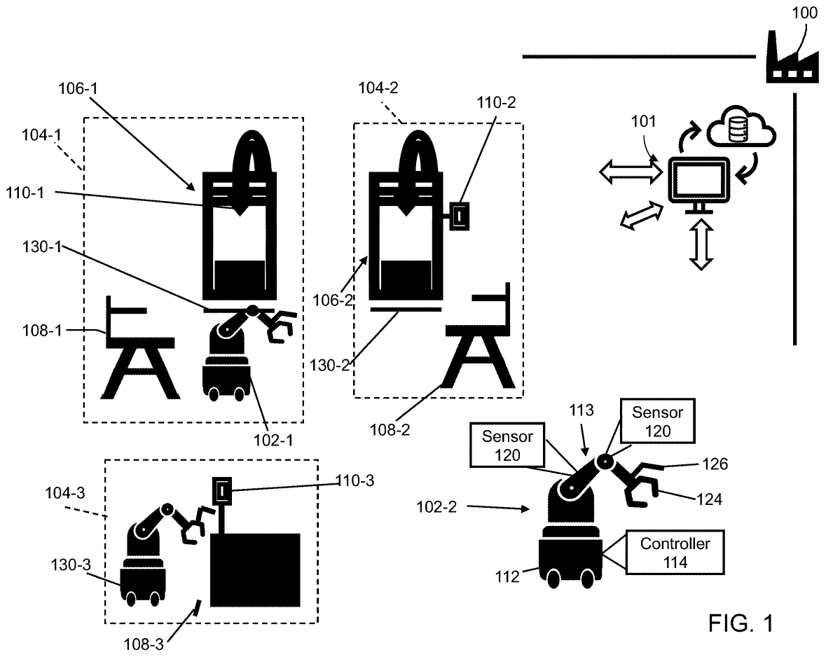

Referring to FIG. 1, an example manufacturing facility 100 may include a manufacturing network system 101 in communication with a plurality of robotic systems 102-1, 102-2, 102-3 (“robotic systems 102,” collectively) provided at the facility 100. The robotic systems 102 travel to one or more manufacturing stations 104-1, 104-2, 104-3 (“manufacturing stations 104”, collectively) to perform various tasks/operations. In an example application, the manufacturing stations 104 may include an automated additive manufacturing production (AAMP) machine 106-1, 106-2 (“AAMP machine 106”, collectively), a staging area 108-1, 108-2 (“staging area 108”, collectively), and/or other equipment/fixture accessible by the robotic systems 102. It should be readily understood that the manufacturing stations 104 may take various configurations and should not be limited to the components described herein. In addition, while three manufacturing stations 104 and three robotic systems 102 are illustrated, the facility 100 may include any number of manufacturing stations 104 and robotic systems 102.

In one form, the manufacturing stations 104 are associated with a positional identifier 110-1, 110-2, 110-3 (“positional identifier 110”, collectively) that is employed by the robotic system 102 to locate itself at the station 104, as described herein. In one example, the positional identifier 110 is provided as a structural feature (e.g., positional identifier 110-1) of the AAMP machine 106, such as an opening, a surface, among other features. In another example, the positional identifier 110 is provided as a positional fixture provided at the manufacturing station 104 (e.g., positional identifiers 110-2 and 110-3). In one form, the positional identifier 110 is configured and designed with sufficient strength and rigidity to provide a force feedback that is detectable by the robotic system 102 to determine the positional offset, as disclosed below.

In one form, the robotic system 102 is an autonomous mobile robot that includes, among other components, an automatic guided vehicle (AGV) 112, a robotic arm 113, and a controller 114 configured to control the AGV 112 and the robotic arm 113. The AGV 112 is configured to transport the robotic arm 113 to various locations within the facility 100, such as the manufacturing stations 104 and may include a base for supporting the robotic arm 113, one or more motors for providing drive power, object detection sensors for detecting objects about the system 102, and a power source, among other components.

In one form, the robotic arm 113 is a multi-axial industrial robotic arm to provide rotational and/or translations movement along multiple axes (e.g., six-axis coordinate system). In one example implementation, the robotic arm 113 includes a plurality of joints and a plurality of actuators that can be operated by the controller 114 to provide the multi-axial movement. In one form, the robotic arm 113 further includes multiple sensors 120, an end-effector tool 124, and a locating feature 126. The sensors are configured to measure force feedback at various locations of the robotic arm 113, such as, but not limited to, the joints and/or the end-effector tool 124, and outputs data indicative of the force feedback to the controller 114. The sensors 120 may include torque sensors, load cells, contact sensor, and/or strain gauges, among others.

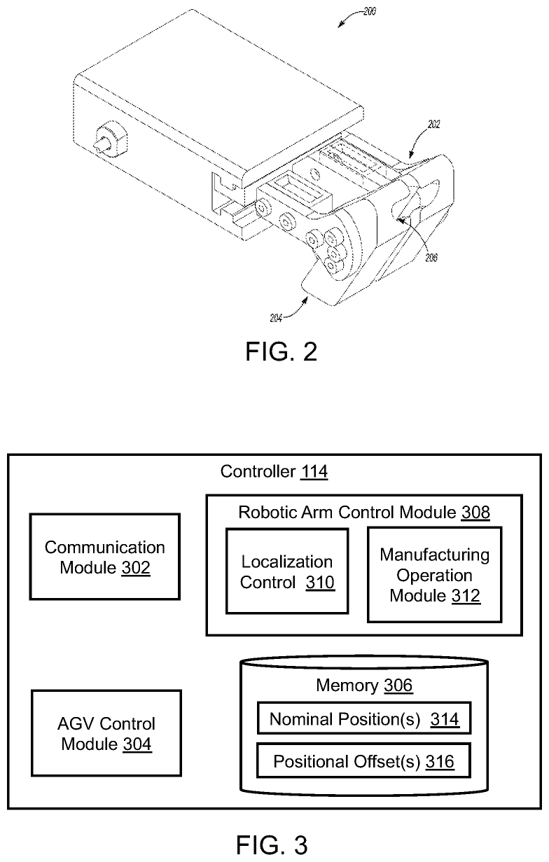

The end-effector tool 124, also known as end-of-arm-tool, is a mechanical device positioned at the end or at a wrist of the robotic arm 113 and is configured to handle one or more workpieces based on an operation to be performed by the robotic system 102. For example, the end-effector tool 124 is configured to grasp and/or move a workpiece to be installed in and/or removed from the AAMP machine 106. In one example application, the end-effector tool 124 is configured to form an interference fit with the workpiece and thus, the tolerance of the end-effector tool 124 with respect to the workpiece may be tight (e.g., ±0.5 mm). Such an end-effector tool is disclosed in Applicant's co-pending application titled “ROBOTIC GRIPPER APPARATUS” which is commonly owned with the present application and the contents of which are incorporated herein by reference in its entirety. Referring to FIG. 2, such an end-effector tool is provided as a gripper apparatus 200 and includes a pair of gripping assemblies 202, where each gripping assembly 202 is moveable in a transverse direction between a first position in which the gripping assembly 202 is to engage the workpiece and a second position in which the gripping assembly 202 is to disengage from the workpiece. Each gripping assembly 202 includes a gripping element 204 defining an interface slot 206 configured to receive the workpiece. While a specific example of an end-effector tool 124 is provided, it should be readily understood that the robotic arm 113 may include other suitable end-effector tools and should not be limited to the example provided herein.

With continuing reference to FIG. 1, as described further below, the locating feature 126 is employed to locate a detected position associated at the manufacturing station 104 and determine a positional offset of the robotic system 102 with respect to a nominal position. In one form, the locating feature 126 is designed with substantial stiffness and rigidity to generate a force that is detectable by the sensors 120 when the locating feature 126 impacts a portion of the positional identifier 110. In one variation, the locating feature 126 is provided as a probe having a length with an elongated body and a blunt end. The locating feature 126 may be made of a hard metal and/or plastic material such as tungsten, iridium, steel, osmium, chromium, titanium, acetal, acrylic, polycarbonate, and the like. In one form, the locating feature 126 is disposed a known offset from the end-effector tool 124. In another form, the locating feature 126 is provided in line of a center axis of end-effector tool 124.

The controller 114 is configured to control the AGV 112 and the robotic arm 113 to determine the positional offset and perform one or more operations at the manufacturing station 104. Referring to FIG. 3, in one form, the controller 114 includes a communication module 302, an AGV control module 304, a memory 306, and a robotic arm control module 308 having a localization control 310. The communication module 302 is configured to communication with various devices in the facility 100 including, but not limited to, the manufacturing network system 101, the AAMP machine 106, and/or a human-machine interface operable by a technician. In one form, the communication module 302 includes hardware and software to establish wired and/or wireless communication links and thus, includes transceiver, router, and/or input-output ports, among other components. Various wireless communication protocols may be employed for establishing one or more wireless communication links such as but not limited to a Bluetooth®-type protocol, a cellular protocol, a wireless fidelity (Wi-Fi)-type protocol, a near-field communication (NFC) protocol, an ultra-wideband (UWB) protocol, among others.

The AGV control module 304 is configured to control the AGV 112 to move from one location to another location of the facility 100 by operating various components within the AGV 112, such as the motors. For example, the communication module 302 may receive a request to perform an operation at a selected manufacturing station 104 from the manufacturing network system 101. Using prestored digital maps of the facility, the AGV control module 304 is configured to define a route to the selected manufacturing station 104 and control the AGV 112 to travel to the station 104 based on the route and on data from the sensors disposed at the AGV 112, where the sensors detect objects that may impede travel of the AGV 112. In one form, the AGV control module 304 includes data indicative of trained robot reference location for the manufacturing stations 104. In one example application, referring to FIG. 1, each of the manufacturing stations 104 is associated with a robot reference location 130-1, 130-2, 130-3 (“robot reference location 130”, collectively) that the robotic system 102 is to align itself with when the robotic system 102 is at the station 104. The robotic system 102 is trained to position itself at the robot reference location, which can be defined as one or more coordinates and can conceptually thought of as a position on a floor upon which the robotic system 102 travels on.

Referring to FIG. 3, the memory 306 is configured to store data including, but not limited to, data employed for the localization control 310, such as: a nominal position(s) 314 and a positional offset(s) 316, which are described further below. The robotic arm control module 308 is configured to control the robotic arm 113 by operating, for example, the actuators provided in the robotic arm 113 to determine the positional offset of the robotic system and perform one or more operations at the selected manufacturing station 104 based on the positional offset. In one form, the robotic arm control module 308 includes the localization control 310 and a manufacturing operation module 312. Once at the selected manufacturing station 104, the robotic arm control module 308 is configured to perform the localization control 310 to tune the position of the robotic arm 113 to improve the accuracy of the movement and/or position of the robotic arm 113.

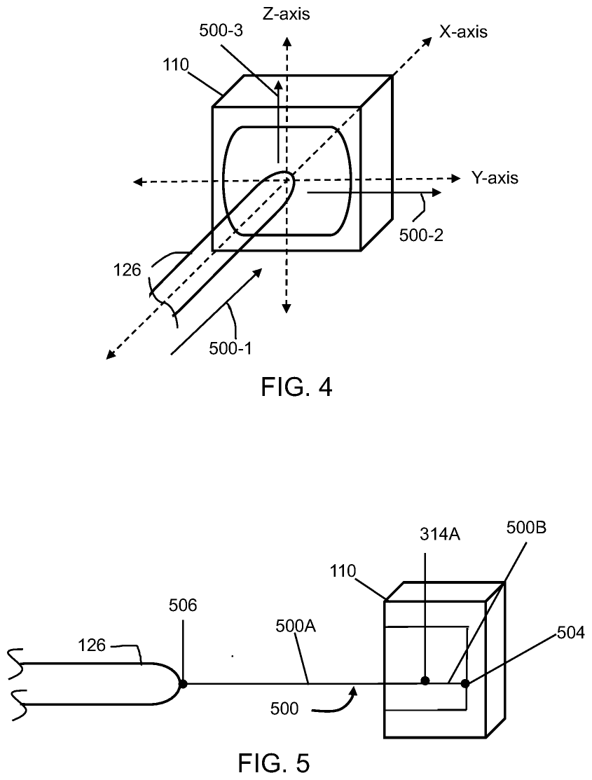

More particularly, referring to FIGS. 4 and 5 a position is generally provided as a point in space that can be defined as coordinates of a coordinate system of the robotic system and in this example, includes an X-axis, a Y-axis and/or a Z-axis. For a given axis, the localization control 310 determines a positional offset of the robotic arm 113 with respect to the nominal position 314 for a respective axis. The nominal position 314 is a trained reference position learned by the robotic system 102 during a setup operation and is associated with the positional identifier 110 such that the locating feature 126 contacts the positional identifier 110 as it approaches and/or passes the nominal position. In one form, the memory 306 can store a nominal position for each axis and/or for each manufacturing station. Alternatively, based on the configuration of the facility 100 and the stations 104, the memory 306 may store the same nominal position(s) 314 for one or more stations 104.

During the localization control 310, the locating feature 126 is moved along a defined path 500 toward a nominal position 314A to a detected position 504, where the detected position 504 is a position of the locating feature 126 at which a force feedback condition is satisfied (FIG. 5). That is, the locating feature 126 contacts the positional identifier 110 as it travels along the defined path 500 causing a force to radiate through the robotic arm 113 and detected by the sensors 120. The localization control 310 compares the force feedback data from the sensors 120 to a force threshold and determines the force feedback condition is satisfied when the force feedback data is equal to or greater than the force threshold. The position of the locating feature 126 and more particularly, the position of the distal end of the locating feature 126 that impacts the positional identifier 110 is provided as the detected position 506. The force threshold may be determined as the robotic system 102 is trained and is a value that provides sufficient indication that the locating feature 126 has impacted a portion of the positional identifier 110 associated with the manufacturing station 108. In one form, the controller 114 may be configured to employ different force thresholds for different stations 104.

A start position 506 is provided as a point at which the locating feature 126 begins to travel toward the nominal position 314. In one form, the defined path 500 is a linear path in which a selected coordinate that is being tuned by the localization control 310 is changing and the other two coordinates are not. For example, a defined path 500-1 is provided for the X-axis, a defined path 500-2 is provided for the Y-axis, and a defined path 500-3 is provided for the Z-axis. It should be readily understood that the defined paths are for exemplary purposes only and that the defined path may be provided in other directions (e.g., −Y-axis).

In the example provided in FIG. 5, the detected position 506 is provided after the nominal position 314, however, it is possible that the detected position 506 is detected before the nominal position 314. For example, if the robotic system 102 is arranged at the robot reference location 130, but is closer to an upper tolerance range of the location 130, the locating feature 126 may interface or contact the positional identifier 110 and satisfy the force feedback condition prior to reaching the nominal position 314A. The localization control 310 determines the positional offset using the detected position that is provided before the nominal position 314. In one form, the localization control 310 may be provided as moving the locating feature 126 along a first defined path toward the nominal position, as the selected defined path and if the force feedback condition is not satisfied when the locating feature 126 reaches the nominal position, the locating feature 126 is moved along a second defined path from the nominal position, as the selected defined path until the force feedback condition is satisfied. Thus, the defined path 500 in FIG. 5 can be conceptually thought of as having defined paths 500A and 500B. In one form, the localization control 310 may be configured to pause movement of the locating feature 126 once it reaches the nominal position 314A prior to continuing along to defined path 500B. Alternatively, the localization control 310 may be configured to continuously move along to the defined path 500B without interruption.

The localization control 310 is configured to determine the positional offset 316 for the respective axis based on the detected position 504 and the nominal position 314. For example, the positional offset 316 is provided as a difference between the detected position 504 and the nominal position 314 to determine a current position along the defined path 500. Once the positional offset 316 for one axis is determined, the localization control 310 determines the positional offset of the next axis if needed. The positional offsets may then be stored in the memory 306 until the operations are completed and/or the robotic system leaves the station 104. In one form, the localization control 310 is performed each time the robotic system is moved to the manufacturing station 104.

The manufacturing operation module 312 is configured to use the positional offset 316 to perform one or more operations at the specific manufacturing station 104. The positional offset 316 provides a corrected position of the locating feature 126 and since the positional relationship of the locating feature 126 and the end-effector tool 124 is known, the positional offset 316 is used to correct the position of the end-effector tool 124 as it is controlled to perform the one or more operations, thereby improving the accuracy of the operation. In one example application, the one or more operations may include retrieving a workpiece from a staging area, placing the workpiece in the AAMP machine, removing the workpiece from the AMMP machine, and/or placing the workpiece in the staging area, among other operations. In one variation, the robotic arm control module 308 is configured to utilize the positional offset to perform one or more operations at a second related manufacturing station 108, where the AGV 112 maintains its current location. That is, the same positional offset may be employed for two machine stations if the AGV 112 of the robotic system 102 does not move after determining the positional offset.

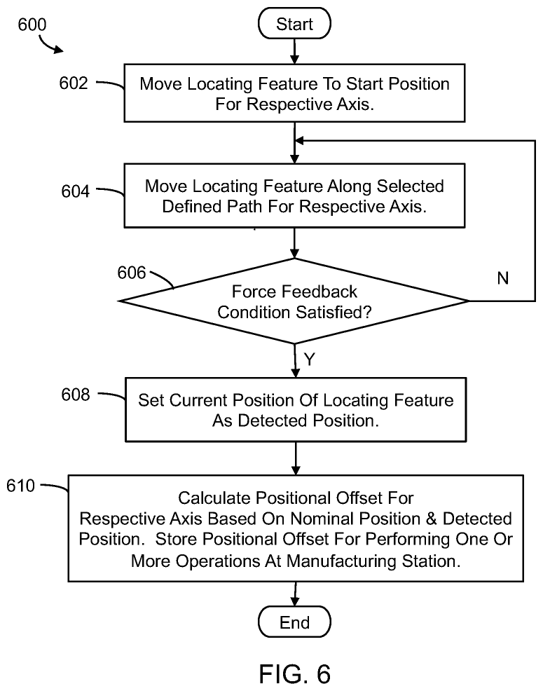

Referring to FIG. 6, an example of a localization control routine 600 performed by the robotic system of the present disclosure. The routine may be performed once the robotic system 102 has arrived at a selected manufacturing station. At 602, for a respective axis, the robotic system moves the locating feature to a start position via the robotic arm and at 604, begins moving the locating feature along a selected defined path. In one form, the nominal position is provided along the selected define path.

At 606, using force feedback data measured by the sensors provided in the robotic arm, the robotic system determines if the force feedback condition is satisfied. That is, the system determines if the force feedback data is equal to or exceeds a force threshold. If no, the robotic system continues to move along the selected defined path. If yes, the robotic system sets/stores a current position of the locating feature as a detected position, at 608. At 610, the robotic system calculates a positional offset for the respective axis based on the nominal position and the detected position, and stores the positional offset so it can be employed for performing one or more operations at the manufacturing. In one form, the robotic system is configured to calculate a positional offset for one or more axes.

It should be readily understood that the localization control routine employed by the robotic system can be configured in various suitable ways and should not be limited to the example provided here.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of operating a robotic system at a manufacturing station in a facility, the method comprising:
moving a locating feature associated with a robotic arm of the robotic system along a selected defined path to a detected position, wherein the detected position is a position of the locating feature when a force feedback condition is satisfied;
calculating a positional offset of the robotic arm based on a nominal position and the detected position of the robotic arm; and
performing, by the robotic system, one or more operations at the manufacturing station using the positional offset.

2. The method of claim 1 further comprising:
having the robotic arm move the locating feature along a first defined path toward the nominal position, as the selected defined path;
measuring force feedback data from one or more sensors provided at the robotic arm to determine whether the force feedback condition is satisfied as the locating feature moves along the selected defined path; and
employing a current position of the locating feature as the detected position in response to the force feedback condition being satisfied.

3. The method of claim 2 further comprising having the robotic arm move the locating feature along a second defined path from the nominal position, as the selected defined path, in response to the force feedback condition not being satisfied when the locating feature is moved to the nominal position.

4. The method of claim 2, wherein the detected position is provided prior to the locating feature reaching the nominal position.

5. The method of claim 1 further comprising:
determining whether force feedback data from one or more sensors provided at the robotic arm is greater than or equal to a force threshold; and
determining the force feedback condition is satisfied in response to the force feedback data being greater than or equal to the force threshold.

6. The method of claim 5, wherein the one or more sensors includes one or more torque sensors.

7. The method of claim 1, wherein the nominal position is a trained reference position learned by the robotic system during a setup operation.

8. The method of claim 1, wherein the nominal position is associated with a structural feature of a machine provided at the manufacturing station, a positional fixture provided at the manufacturing station, or a combination thereof.

9. The method of claim 1, wherein the one or more operations include having the robotic system position a workpiece at a machine, remove the workpiece from the machine, or a combination hereof, wherein the machine is provided at the manufacturing station.

10. A robotic system comprising:
a locating feature;
a robotic arm associated with the locating feature and includes one or more sensors disposed thereon; and
a controller configured to:
move the locating feature along a selected defined path to a detected position, wherein the detected position is a position of the locating feature in response to a force feedback condition being satisfied at a manufacturing station;
calculate a positional offset based on a nominal position and the detected position, wherein the nominal position is associated with the manufacturing station; and
have the robotic arm perform one or more operations at the manufacturing station using the positional offset.

11. The robotic system of claim 10, wherein the controller is further configured to:
have the robotic arm move the locating feature along a first defined path toward the nominal position, as the selected defined path;
measure force feedback data from one or more sensors provided on the robotic arm to determine whether the force feedback condition is satisfied as the locating feature moves along the selected defined path; and
employ a current position of the robotic arm as the detected position in response to the force feedback condition being satisfied.

12. The robotic system of claim 11, wherein the controller is further configured to have the robotic arm move the locating feature along a second defined path from the nominal position, as the selected defined path, in response to the force feedback condition not being satisfied when the locating feature is initially moved to the nominal position.

13. The robotic system of claim 11, wherein the detected position is provided prior to the locating feature reaching the nominal position.

14. The robotic system of claim 10, wherein the controller is further configured to:
determine whether force feedback data from the one or more sensors at the robotic arm is greater than or equal to a force threshold; and
determine the force feedback condition is satisfied in response to the force feedback data being greater than or equal to the force threshold.

15. The robotic system of claim 10, wherein the nominal position is a trained reference position learned by the robotic system during a setup operation.

16. The robotic system of claim 10, wherein the one or more sensors include one or more torque sensors.

17. The robotic system of claim 10, wherein the nominal position is associated with a structural feature of a machine of the manufacturing station, a positional fixture associated with the manufacturing station, or a combination thereof.

18. The robotic system of claim 10 further comprising an automatic guided vehicle coupled to the robotic arm and configured to transport the robotic arm from a first location to the manufacturing station.

19. The robotic system of claim 11, further comprising:
a gripper attached to the robotic arm and configured to handle a workpiece, wherein
as an operation from among the one or more operations, the controller is configured to have the robotic arm and the gripper:
position the workpiece at a machine,
remove the workpiece from the machine, or
a combination hereof,
wherein the machine is provided at the manufacturing station.

20. A method for operating a robotic system at a manufacturing station in a facility, the method comprising:
moving a locating feature associated with a robotic arm of the robotic system along a selected defined path, wherein a nominal position is provided along the selected defined path, and the nominal position is a trained reference position associated with the manufacturing station;
measuring force feedback data from one or more sensors provided at the robotic arm to determine whether the force feedback condition is satisfied as the locating feature moves along the selected defined path;
calculating a positional offset of the robotic arm based on the nominal position and a detected position, wherein the detected position is a position of the locating feature when the force feedback condition is satisfied; and
performing, by the robotic system, one or more operations at the manufacturing station using the positional offset.
